(19) United States
(12) Patent Application Publication
(10) Pub. No.: US 2025/0335821 A1
(43) Pub. Date: Oct. 30, 2025

(54) TASK PROCESSING FOR A DIGITAL ASSISTANT

(71) Applicant: Beijing Zitiao Network Technology Co., Ltd., Beijing (CN)

(72) Inventors: Longteng Peng, Beijing (CN); Weizhi Yan, Beijing (CN)

(21) Appl. No.: 18/801,910

(22) Filed: Aug. 13, 2024

(30) Foreign Application Priority Data
Apr. 30, 2024 (CN) 202410545266.8

(51) Int. Cl. G06N 20/00

(52) U.S. Cl. CPC G06N 20/00

(57) ABSTRACT

Embodiments of this specification describe technologies for task processing. One method includes: in response to receiving a request for a digital assistant, obtaining a processing configuration associated with the digital assistant, the processing configuration comprising one or more inference rules, at least one of the one or more inference rules being configured to perform inference on the request using a corresponding first-type machine learning model; processing the request based on the processing configuration to determine a response of the digital assistant to the request; and in response to a failure to process the request based on the processing configuration, performing inference on the request by invoking a second-type machine learning model to determine a response of the digital assistant to the request, wherein a resource cost of invoking the second-type machine learning model is greater than a resource cost of invoking the first-type machine learning model.

### CROSS REFERENCE TO RELATED APPLICATIONS

This application claims priority to Chinese Patent Application No. 202410545266.8, filed with the Chinese Patent Office on Apr. 30, 2024, and entitled ‘METHOD, APPARATUS, DEVICE, AND STORAGE MEDIUM FOR TASK PROCESSING’, which is incorporated here by reference in its entirety.

### FIELD

Example embodiments of the present specification generally relate to the field of computers, and in particular, to task processing.

### BACKGROUND

Digital assistants are provided to assist users with various task processing needs in different applications and scenarios. Digital assistants typically have intelligent dialog and task processing capabilities. During interaction with a digital assistant, an interaction message is requested, and the digital assistant responds to the request by providing a response message. Typically, the digital assistant can support user inputs providing questions in a natural language and perform tasks and provide responses based on the understanding of the natural language input and logical reasoning abilities of the digital assistants. Digital assistant interaction has become a favorite and relied upon tool due to its flexibility and convenience.

### SUMMARY

In a first aspect of the present disclosure, a method of task processing is provided. The method comprises: in response to receiving a request for a digital assistant, obtaining a processing configuration associated with the digital assistant, the processing configuration comprising one or more inference rules, at least one of the one or more inference rules being configured to perform inference on the request using a corresponding first-type machine learning model; processing the request based on the processing configuration to determine a response of the digital assistant to the request, wherein processing the request based on the processing configuration at least comprises: performing, based on the at least one inference rule, inference on the request by invoking the corresponding first-type machine learning model; and in response to a failure to process the request based on the processing configuration, performing inference on the request by invoking a second-type machine learning model to determine a response of the digital assistant to the request, wherein a resource cost of invoking the second-type machine learning model is greater than a resource cost of invoking the first-type machine learning model.

In a second aspect of the present disclosure, an apparatus for task processing is provided, comprising: a processing configuration obtaining module configured to, in response to receiving a request for a digital assistant, obtain a processing configuration associated with the digital assistant, the processing configuration comprising one or more inference rules, at least one of the one or more inference rules being configured to perform inference on the request with a corresponding first-type machine learning model; a first response determining module configured to process the request based on the processing configuration to determine a response of the digital assistant to the request, wherein processing the request based on the processing configuration at least comprises: performing, based on the at least one inference rule, inference on the request by invoking the first-type machine learning model; and a second response determining module configured to, in response to a failure to process the request based on the processing configuration, perform inference on the request by invoking a second-type machine learning model to determine a response of the digital assistant to the request, wherein a resource cost of invoking the second-type machine learning model is greater than a resource cost of invoking the first-type machine learning model.

In a third aspect of the present disclosure, an electronic device is provided. The device comprises at least one processing unit; and at least one memory coupled to the at least one processing unit and storing instructions for execution by the at least one processing unit, the instructions, when executed by the at least one processing unit, cause the electronic device to perform operations of the method of the first aspect.

In a fourth aspect of the present disclosure, a computer-readable storage medium is provided. The medium has a computer program stored thereon, the computer program being executable by a processor to perform operations that implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a schematic diagram of an example environment.

FIG. 2 shows a block diagram of an example process of task processing.

FIG. 3 shows one of the schematic diagrams of an example

FIG. 4 shows a second schematic diagram of an example processing configuration of a digital assistant.

FIG. 5 shows an overall flowchart of an example method of task processing.

FIG. 6 shows a schematic structural block diagram of an apparatus for task processing.

FIG. 7 shows a block diagram of an example electronic device.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth in this specification, but rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms ‘comprising’, and the like should be understood to comprise ‘comprising but not limited to’. The term ‘based on’ should be understood as ‘based at least in part on’. The terms ‘one embodiment’ or ‘the embodiment’ should be understood as ‘at least one embodiment’. The term ‘some embodiments’ should be understood as ‘at least some embodiments’. Other explicit and implicit definitions may also be included below.

Unless explicitly stated, ‘in response to A’ performs one step and does not imply that this step is performed immediately after ‘A’ but may comprise one or more intermediate steps.

It may be understood that the data involved in the technical solution (comprising but not limited to the data itself, the obtaining, using, storing or deleting of the data) should follow the requirements of the corresponding laws and regulations and related regulations.

It can be understood that before using the technical solutions disclosed in some embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may comprise any type of rights body, such as individuals, businesses, and groups.

For example, in response to receiving an active request from a user, prompt information is sent to the related user to explicitly prompt the related user, and the operation requested to be executed will need to obtain and use the information of the related user, thereby enabling the relevant user to autonomously choose whether or not to provide the information to the software or hardware such as an electronic device, an application program, a server, or a storage medium that performs the operation of the technical solution of the present disclosure, in accordance with the prompt information.

As an optional, but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select ‘agree’ or ‘not agree’ to provide information to the electronic device.

It may be understood that the above notification and process of obtaining user authorization are merely illustrative and do not limit the manner of implementation of the present disclosure, and other methods that satisfy the relevant laws and regulations may also be applied in the manner of implementation of the present disclosure.

As used in this specification, the term “model” can be used to learn from the training data a correspondence between the corresponding inputs and outputs, so that the corresponding outputs can be generated for the given inputs after the training is completed. Model generation can be based on machine learning techniques. Deep learning is a machine learning algorithm that processes inputs and provides corresponding outputs by using multiple layers of processing units. A neural network model is an example of a deep learning based model. In the present disclosure, “model” may also be referred to as a “machine learning model”, “learning model”, “machine learning network” or “learning network,” and these terms are used interchangeably.

Digital assistants can be used as tools for people to work, learn and live effectively. Typically, the development of a digital assistant is similar to the development of a general application in that a developer with programming skills is required to define the capabilities of the digital assistant by writing complex code and deploying the digital assistant on an appropriate runtime platform so that a user can download, install, and use the digital assistant.

Generally, in the process of user interaction with a digital assistant, the digital assistant will choose the safest way to respond to the user, i.e., it will choose a model with a complex structure and a large number of parameters to respond to. However, although this type of model can generate more accurate and richer content, it will take longer to run and consume more resources. This usually results in long waiting times for users. If there is a network failure during the waiting process (e.g., in a subway scenario, the network signal is unstable), the model will not be able to output the final result and the user needs to re-input the model, which in the long run will result in a degradation of the user's experience.

According to an embodiment of the present disclosure, a method of task processing is provided. According to the method, in response to receiving a request for a digital assistant, a processing configuration associated with the digital assistant is obtained, the processing configuration comprising one or more inference rules, at least one of the one or more inference rules being configured to perform inference on the request using a corresponding first-type machine learning model. The request is processed based on the processing configuration to determine a response of the digital assistant to the request, where processing the request based on the processing configuration at least comprises: performing, based on the at least one inference rule, inference on the request by invoking the corresponding first-type machine learning model; and in response to a failure to process the request based on the processing configuration, inference is performed on the request by invoking a second-type machine learning model to determine a response of the digital assistant to the request. A resource cost of invoking the second-type machine learning model is greater than a resource cost of invoking the first-type machine learning model.

Accordingly, the assistant application platform can first use the first-type machine learning model with low resource cost to process the request according to the processing configuration. Only in the case where the first-type machine learning model is unable to generate the response to the request through its inference, the second-type machine learning model, which is more comprehensive but also consumes more computational resources, will be invoked to generate the response to the request. In a first aspect, if the first-type machine learning model can be used, then it can effectively reduce the waiting time of the user and quickly generate the response. On the other hand, even if the first-type machine learning model fails to process the user input, the second-type machine learning model can be utilized to ensure that the request is processed successfully and complete the normal interaction with the user.

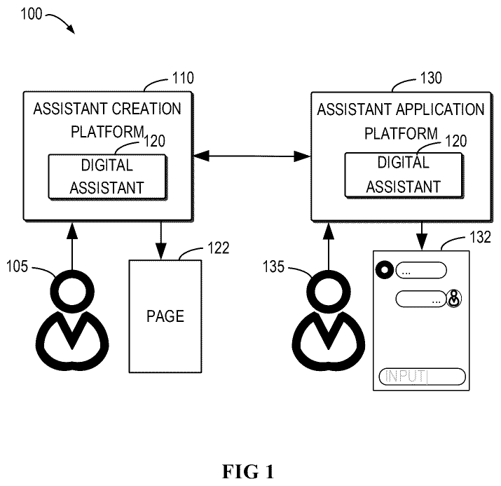

FIG. 1 shows a schematic diagram of an example environment 100 in which embodiments of the present disclosure can be implemented. The environment 100 involves an assistant creation platform 110 and an assistant application platform 130.

As shown in FIG. 1, the assistant creation platform 110 may provide a user 105 with a creation and publication environment for digital assistants. In some embodiments, the assistant creation platform 110 may be a low-code platform that provides a collection of tools for digital assistant creation. The assistant creation platform 110 may support visual development of digital assistants, thereby allowing developers to skip the manual coding process and speed up the development cycle and reduce the cost of the application. The assistant creation platform 110 may support any suitable platform for users to develop digital assistants and other types of applications, which may comprise, for example, an application platform as a service (aPaaS) based platform. Such a platform can support the user in the efficient development of the application, enabling operations such as application creation, application functionality adjustment, and the like.

The assistant creation platform 110 can be deployed locally on a terminal device of the user 105 and/or can be supported by a remote server. For example, a client with the assistant creation platform 110 may be run on the terminal device of the user 105, which can support the interaction of the user with the assistant creation platform 110. In the case where the assistant creation platform 110 is run locally on the terminal device of the user, the user 105 can directly use the client to interact with the local assistant creation platform 110. In the case where the assistant creation platform 110 is run on a server level device, the server-side device can implement the provision of services to the client running on the terminal device based on the communication connection between the assistant creation platform 110 and the terminal device. The assistant creation platform 110 can present a corresponding page 122 to the user 105 based on the operation of the user 105 to output and/or receive information from the user 105.

In some embodiments, the assistant creation platform 110 may be associated with a corresponding database in which data or information required for the digital assistant creation process supported by the assistant creation platform 110 is stored. For example, the database may store code and descriptive information corresponding to the various functional modules used to compose the digital assistant, etc. The assistant creation platform 110 may also perform operations such as invoking, adding, deleting, updating, and the like on the functional blocks in the database. The database may also store operations that may be performed on different functional blocks. By way of example, in a scenario where a digital assistant is to be created, the assistant creation platform 110 may invoke corresponding functional blocks from the database to build the digital assistant.

In some embodiments of the present disclosure, the user 105 may create the digital assistant 120 on the assistant creation platform 110 as desired and post the digital assistant 120. The digital assistant 120 may be posted to any appropriate assistant application platform 130, provided that the assistant application platform 130 can support the operation of the digital assistant 120. Upon posting, the digital assistant 120 may be used for dialog interaction with the user 135. A client of the assistant application platform 130 may present an interaction window 132 of the digital assistant 120, such as a session window, in a client interface. For example, the assistant application platform 130 may execute an application that generates the interaction window 132 for presentation to the user 135. The digital assistant 120 acts as an intelligent assistant with intelligent dialog and information processing capabilities. The user 135 may enter a session message in the session window, and the digital assistant 120 may determine a response message and present the response message to the user in the interaction window 132 based on the created configuration information. In some embodiments, depending on the configuration of the digital assistant 120, the interaction message with the digital assistant 120 may comprise a multimodal form of message, such as a text message (e.g., natural language text), a speech message, an image message, a video message, and the like.

The assistant creation platform 110 and/or the assistant application platform 130 may run on an appropriate electronic device. An electronic device in this specification may be any suitable type of device with computing power, including a terminal device or a server device. The terminal device may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, positioning devices, television receivers, radio broadcast receivers, e-book devices, gaming devices, or any combination of the foregoing, comprising accessories and peripherals for such devices or any combination thereof. Server devices may, for example, comprise computing systems/servers such as mainframes, edge computing nodes, computing devices in cloud environments, and the like. In some embodiments, assistant creation platform 110 and/or assistant application platform 130 may be implemented based on cloud services.

It should be understood that the structure and functionality of the environment 100 is described for example purposes only and does not imply any limitation on the scope of the present disclosure. For example, while FIG. 1 illustrates a single user interacting with the assistant creation platform 110 and a single user interacting with the assistant application platform 130, a plurality of users may in fact access the assistant creation platform 110 to each create a digital assistant, and each digital assistant may be used to interact with a plurality of users.

Some example embodiments of the present disclosure will be described in detail below with reference to the examples of the accompanying drawings. It should be understood that the pages illustrated in the accompanying drawings are merely examples and that various page designs may actually exist. Individual graphical elements on the page may have different arrangements and different visual representations, one or more of the elements may be omitted or replaced, and one or more other elements may be present. Embodiments of the present disclosure are not limited in this regard.

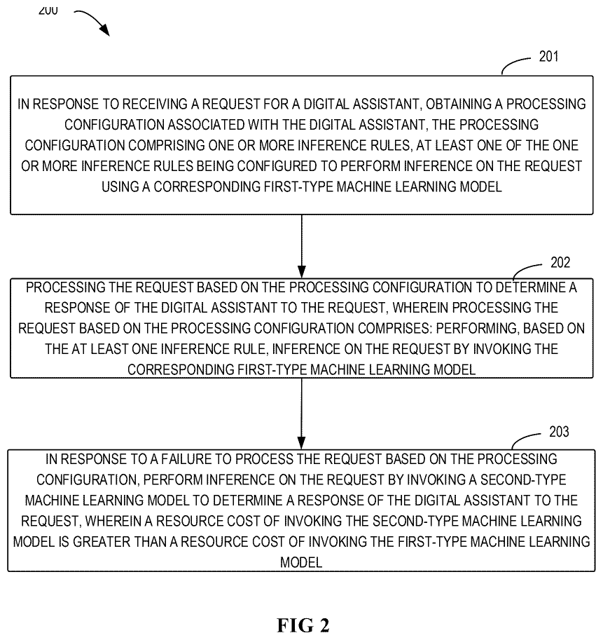

FIG. 2 shows an example flow 200 of an example method of task processing according to some embodiments of the present disclosure. For ease of discussion, flow 200 will be described with reference to the environment of FIG. 1. The process 200 relates to the application stage of the digital assistant 120 after the digital assistant 120 is created, and thus may be implemented at an electronic device. It should be understood that the operations described below with respect to the assistant application platform 130 and/or the digital assistant 120 may specifically be performed by the electronic device running the assistant application platform 130 and/or the digital assistant 120. For example, the electronic device may be a terminal device and/or a server or may be understood to be executed with the aid of an application corresponding to the assistant application platform 130 and/or the digital assistant 120.

In conjunction with FIG. 2, at block 201, the electronic device, in response to receiving a request for a digital assistant, obtains a processing configuration associated with the digital assistant. The processing configuration comprises one or more inference rules where at least one of the one or more inference rules is configured to perform inference on the request with a corresponding first-type machine learning model.

The electronic device may be a terminal device and/or a server running the assistant application platform 130 and/or the digital assistant 120, i.e., the assistant application platform 130 and/or the digital assistant 120 is implemented at the electronic device.

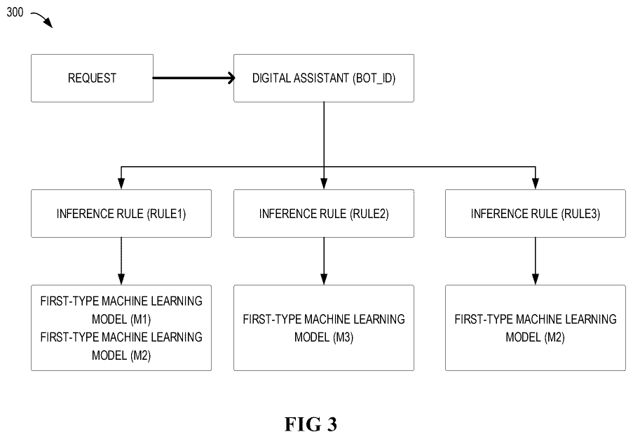

FIG. 3 shows a schematic diagram of a processing configuration of a digital assistant according to some embodiments of the present disclosure. The Bot_ID shown in FIG. 3 may be used to indicate an identification of a digital assistant with specified interaction capabilities. By way of example, the digital assistant may be a digital assistant with music broadcasting capabilities, a digital assistant with conference hosting capabilities, a digital assistant with ticket purchasing and ordering capabilities, and so on. Each digital assistant has a corresponding identification.

For each digital assistant, a processing configuration associated with the digital assistant may be constructed in advance or in real time. The processing configuration may be used to parse the request to generate a response to the request. In conjunction with Table 1, the processing configurations comprise at least one inference rule, each of which may be configured to invoke at least a first-type machine learning model to inference on the request. The association of the inference rules with the first-type machine learning models may be pre-configured.

TABLE 1
‘Bot_ID’: 1

```
  ‘RULE’:[
{ ‘rule_type”: [1] // [1] refers to the first-type machine learning model, [2] refers to the
rule engine, [3] refers to XXX, [4] refers to XXXX
  ‘payload’: ‘’// invocation strategy
  ‘action_type’: [2] // action sequence [1] refers to invoking the specified model, [2] refers
to invoking the tool, [3] refers to prompt input, [4] refers to XXXX
‘priority’: 1// Current inference rule priority
    },
{ ‘rule_type”: [2] // [1] refers to the first-type machine learning model, [2] refers to the
rule engine, [3] refers to XXX, [4] refers to XXXX
  ‘payload’: ‘’, // invocation strategy
  ‘action_type’: [1] // action sequence [1] refers to invoking the large model, [2] refers to
invoking the tool, [3] refers to prompt input, [4] refers to XXXX, [5] refers to XXX
  ‘priority’: 2// Current inference rule priority
    },
...
```

The Bot_ID of the digital assistant in Table 1 is 1. The example in Table 1 shows two inference rules in the processing configuration. For each rule, the configuration includes the type (rule_type) of the object to which the inference rule is associated. The type of the object to which the inference rule is associated may indicate a first-type machine learning model, or it may indicate a rule engine, for example.

In addition, the configuration includes an invocation strategy (payload) for the associated object, and the invocation strategy needs to include at least the invocation address of the object being invoked. Furthermore, as shown in Table 2, using a small natural language processing (NLP) model as an example of an invoked object, the invocation strategy may include the invocation address of the model, and may also include the traffic field (biz_scene) of the model, the corresponding Bot_ID of the model, and the model input requirements for the model.

In addition, the configuration includes an action sequence (action_type) and a priority. The action sequence may be used to indicate an action sequence to be executed based on the results of the inference rules (e.g., for an invocation of a tool, for an invocation of a specified machine learning model, etc.). The priorities can be used to indicate that in the case where successful inferences are obtained using a plurality of inference rules, the one with the highest priority is selected as the target inference result.

TABLE 2

```
//call NLU
{
  ‘url’: ‘https://xxx.com’
  ‘path’: /api/xxx
  ‘biz_scene’: ‘’// music, navigation, shopping, ......
  ‘Bot_ID’:1 // Identification of the Bot
  ‘payload’: {
  ‘query’: ‘query’,
‘chat_context’: ‘User history input’
    }
}
```

In conjunction with the example shown in FIG. 3, the processing configuration associated with the digital assistant comprises three inference rules corresponding to RULE1, RULE2, and RULE3. By way of example, in each rule, an invocation strategy for the corresponding first-type machine model may be included. For example, two first-type machine learning models (M₁ and M₂, which may be used as identification of the first-type machine learning models) are associated in the inference rule RULE1. From this, it can be represented that when the inference rule RULE1 is executed, this inference rule can invoke two machine learning models to perform inference on the request based on the invocation strategy. Similarly, one first-type machine learning model is associated with both the inference rule RULE2 and the inference rule RULE3, indicating that the inference rule can invoke a respective first-type machine learning model based on the invocation strategy to perform inference on the request. For example, the inference rule RULE2 may invoke a first-type machine learning model based on the invocation strategy (M₃, which may be used as an identification of the first-type machine learning model), and the inference rule RULE3 may invoke a first-type machine learning model based on the invocation strategy (M₄, which may be used as an identification of the first-type machine learning model). The invocation strategy may be configured when the inference rule is associated with the particular first-type machine learning model. By way of example, the invocation strategy may include at least an invocation address of the first-type machine learning model.

The machine learning models having the first-type consume relatively few resources compared to the machine learning model of a second-type. By way of example, the resource cost may comprise the following: the first is a model architecture. The first-type machine learning model can have a simple model architecture, which means that the number of parameters of the first-type machine learning model is relatively small. Moreover, the simple model architecture also means that the time required for training the first-type machine learning model is also relatively short. The second is computational power, the first-type machine learning model requires less computational resources and can be trained and perform inference functions on simpler hardware as compared to the second-type of machine learning model. The third is storage requirements, the first-type machine learning models have lower storage requirements as compared to the second-type of machine learning models and can therefore be deployed on devices with limited storage. The fourth is scenarios, the first-type machine learning models have relatively single inference scenarios and cannot achieve coverage of multiple scenarios. The fifth is the tariff, the first-type machine learning model has a low tariff for use and can even be used for free. In some cases, the first-type machine learning models can also be referred to as small models, e.g., they can be small language models, small Natural Language Processing (NLP) models, or specialized models configured to handle a particular task. In contrast, the second-type machine learning models are also referred to as large models, such as being large language models, or other machine learning models with more generalized and powerful processing capabilities. Embodiments of the present disclosure do not limit the specific examples of the first-type machine learning models and the second-type machine learning models.

At block 202, the electronic device processes the request based on the processing configuration to determine a response of the digital assistant to the request, wherein processing the request based on the processing configuration at least comprises: performing, based on the at least one inference rule, inference on the request by invoking the first-type machine learning model associated with the at least one inference rule.

For example, the electronic device receives a request for “Can you play a more lyrical piece of music?” In the example shown in FIG. 3, the electronic device may send the request to each of the three inference rules, and each of the three inference rules invokes its corresponding associated first-type machine model to perform inference on the request.

Take the request “Can you play a more lyrical piece of music” as an example. The three inference rules in the example shown in FIG. 3 invoke their corresponding associated first-type machine learning models to perform inference on “Can you play a more lyrical piece of music?”. For the first-type machine learning model, the output of the model can be summarized into several items. The first item is to get accurate inference results. The second item is to get a vague inference result. The third item is that no inference results can be obtained. If the electronic device learns that the model output is the first one, then it can be assumed that the processing configuration can be used to determine the response to the request, i.e., it can be concluded how to respond to “Can you play a more lyrical piece of music”. If the electronic device is informed that the model output is the third one, then it can be indicated that the processing configuration is not able to determine the output of the digital assistant's response to the user, and then block 203 can be executed. Alternatively, if the electronic device is informed that the model output is the second one, then other ways of determining the response to the request can be used, as will be described in more detail later in the response process.

At block 203, in response to a failure to process the request based on the processing configuration, the electronic device performs inference on the request by invoking a second-type machine learning model to determine a response of the digital assistant to the request. A resource cost of invoking the second-type machine learning model is greater than a resource cost of invoking the first-type machine learning model.

As described above, if the electronic device is informed that the model outputs that an inference result is unavailable, this may indicate that inference to the request cannot be accomplished with respect to the inference rules in the digital assistant processing configuration. By way of example, reasons for such a situation may include that the request is complex or that the request is a scenario for which the first-type machine learning model has not been trained, and so forth. In the case where the electronic device determines that the inference rules in the processing configuration are unable to complete the inference on the request, the second-type machine learning model may be invoked to perform inference on the request to determine the digital assistant's response to the request. Compared to the first-type machine learning model, the second-type machine learning model outperforms the first-type machine learning model in terms of model architecture, computational power, and scenario coverage, and thus can be used with more complex requests. However, compared to the first-type machine learning model, the resource cost of invoking the second-type machine learning model will be significantly larger than that of invoking the first-type machine model.

Through the above process, the assistant application platform will first employ the first-type machine learning model having a low resource cost to process the request based on the processing configuration. Only when the first-type machine learning model is unable to inference a response to the request, the second-type machine learning model, which is more comprehensive in capability but also consumes more computational resources, is invoked to generate a response to the request. For one thing, if the first-type machine learning model can be used, then it can effectively reduce the waiting time of the user to quickly generate a response, and for another, even if the first-type machine learning model fails to process the user's input, the second-type machine learning model can be used as a backstop to ensure normal interaction with the user.

In some embodiments, each of the at least one inference rule indicates an invocation strategy for at least one first-type machine learning model, the invocation strategy comprising an invocation address and a model input requirement for the at least one first-type machine learning model. Based on this, for each of the at least one inference rule, the electronic device generates, based on the model input requirement, a model input for each of the at least one first-type machine learning model; the at least one first-type machine learning model is invoked via the invocation address with the generated model input respectively to obtain a model output; and an inference result is determined for the request based on at least the model output corresponding to the at least one inference rule.

Taking the inference rule RULE1 in FIG. 3 as an example, the inference rule RULE1 may include two different first-type machine learning models that can be invoked in association with the inference rule.

By way of example, the type of the first-type machine learning model may be a model of the prediction type or a model of the understanding type, and so forth. Further, in the inference rules, an invocation strategy for the first-type machine learning model may be included, the invocation strategy comprising an invocation address and a model input requirement for each first-type machine learning model of the at least one first-type machine learning model. The invocation address may be a Uniform Resource Locator (URL). The model input requirements may indicate a request, a history of inputs or an applicability scenario for the combined model, and so forth. In examples where the applicable scenario for the model is taken into consideration, the model may be used in a driving environment or in a home office environment, or the model may have limitations on the length or type (speech or text) of the input.

The invocation strategy for each first-type machine learning model is already determined during the configuration of the inference rules. That is, if the inference rule RULE1 performs the inference, then two first-type machine learning models (M₁ and M₂) are invoked.

Still taking the inference rule RULE1 in FIG. 3 as an example, the inference rule RULE1 comprises two associated first-type machine learning models. Therefore, the invocation strategy includes the invocation addresses of the two first-type machine learning models and the model input requirements corresponding to the two first-type machine learning models, respectively. In the example where the model input requirement of the first first-type machine learning model M₁ includes the request, the request can be directly used as a model input to the first one of first-type machine learning model M₁. In the example where the model input requirement of the second first-type machine learning model M₂ includes the request and a history input, a combination of the history inputs for a certain period of time as well as the current request can be used as a model input to the second one of first-type machine learning model M₂. The output of the first first-type machine learning model M₁ can be obtained via the invocation address of the first first-type machine learning model M₁, by using the model input of the first first-type machine learning model M₁. Similarly, the output of the second first-type machine learning model M₂ can be obtained via the invocation address of the second first-type machine learning model M₂, by using the model M₂ input of the second first-type machine learning model.

Still with reference to the request “Can you play a more lyrical music” as an example, the electronic device sends the request to the inference rule RULE1. In conjunction with FIG. 3, the electronic device sends the request to the inference rule RULE1. In the inference rule RULE1, the first one of first-type machine learning model M₁ is configured to perform inference on the music playing control command, and the second one of first-type machine learning model M₂ is configured to perform inference on the playing content. Then, in the case where both first-type machine learning models can accurately inference, the model output obtained by the first one of first-type machine learning model M₁ is the playing of music and the model output obtained by the second one of first-type machine learning model M₂ is the lyrical music. If it is determined, in combination with the historical input, that the user prefers ethnic music or prefers singer A, then the model output can further be a lyrical song from ethnic music, or a lyrical song sung by singer A.

That is, if there is a plurality of first-type machine learning models associated with the inference rule, then the plurality of first-type machine learning models will all be invoked to complete the inference on the request, and each of the first-type machine models will correspondingly have an inference result.

Still in conjunction with FIG. 3, the electronic device sends the request to inference rule RULE2 at the same time. Still using the example of inference rule RULE2, inference rule RULE2 includes a first-type machine learning model M₃ associated with it, referred to in this specification as a third first-type machine learning model. It is assumed that the third first-type machine learning model M₃ is configured to perform inference on an edit instruction for a music playlist. The input used for the input is also similarly sent by the electronic device to the inference rule RULE3, and the corresponding inference result is obtained by one of the first-type machine learning models M₂ associated with the inference rule RULE3.

Then, the electronic device, based on the model output in the inference rule RULE1, the model output in the inference rule RULE2, and the model output in the inference rule RULE3, may determine the model output in the inference rule RULE1 as a result of the inference to the request. A processing configuration of the same digital assistant may include a plurality of inference rules, only three of which are examples illustrated in FIG. 3. It should be noted that the 3 inference rules in FIG. 3 do not bind or influence the actual situation.

In some embodiments, each of the at least one inference rule further indicates an action sequence to be executed, in which case, for a first inference rule of the at least one inference rule, the electronic device, in response to an inference result indicating at least one action execution parameter, executes an action sequence indicated by the first inference rule based on the at least one action execution parameter, the inference result being obtained by invoking a first-type machine learning model in the first inference rule; and a response of the digital assistant to the request is determined based on an execution result of the action sequence.

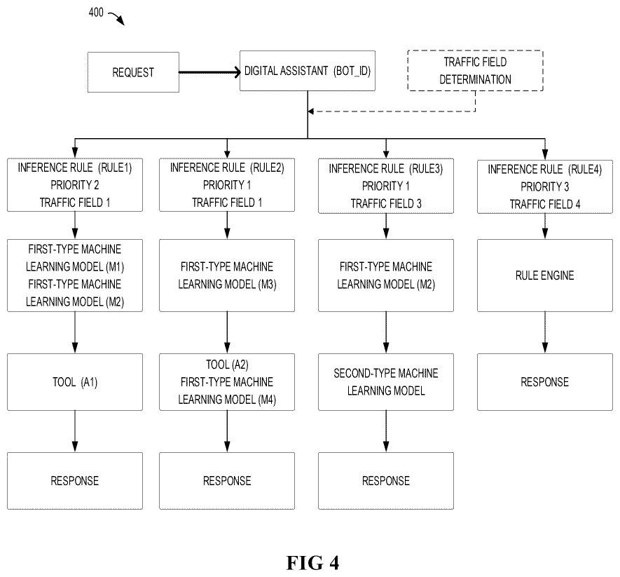

As previously described, a first-type machine learning model associated with the inference rule is included in the inference rule. FIG. 4 illustrates a schematic diagram of a processing configuration of a digital assistant according to some embodiments of the present disclosure. In conjunction with FIG. 4, there is also included in the inference rule an action sequence to be subsequently executed based on the inference results of the first-type machine learning model. By way of example, the actions in the action sequence may indicate actions in the form of labels. The actions in the action sequence may comprise obtaining an accurate inference result based on the inference result, then the tool may be invoked based on the inference result, or other specified models may be invoked. The action in the action sequence may also be to readjust the request based on the inference result, etc. The electronic device determines a response to the request by the digital assistant based on the action sequence indicated in the inference rule. The action sequence includes at least one action.

The actions in the action sequence are also determined when configuring the processing configuration. By way of example, the actions in the action sequence may include performing at least one invocation of a tool, such that the inference results are further processed with the invoked tool. Alternatively, the actions in the action sequence may include executing at least one invocation of a specified machine learning model, such that the specified machine learning uses the inference results to perform re-reasoning, derive a response to the request based on the inference results, or update the request based on the inference results. Further, the actions in the action sequence may include executing the invocation of the specified machine learning model first, followed by executing the invocation of the tool; or executing the invocation of the tool first, followed by executing the invocation of the specified machine learning model, and so forth.

Taking the inference rule RULE1 in FIG. 4 as the first inference rule as an example, the first inference rule is associated with two first-type machine learning models, and the “lyrical music” indicated by the inference result of one of the first-type machine learning models can be corresponded to the action execution parameter. Similarly, if the inference result of the first-type machine model indicates “jump to a specific location in the music (e.g., a certain lyric or a certain point in time, etc.)” or the inference result indicates “play at a specified speed (e.g., 1.25× or 2×, etc.)”, then the output music can be played at the specific location and/or at the specified speed. The specific position in the music and the specified speed can then correspond to an action execution parameter. The electronic device, upon being informed that the inference result obtained by the first-type machine learning model indicates at least one action execution parameter, may execute the action sequence based on the action execution parameter.

In the example of an action in an action sequence being invoked by an execution tool, the electronic device may generate an invocation request based on an action execution parameter, so that the invocation request is sent to the invoked tool to execute the corresponding action. In the example where the action execution parameter is “lyrical music”, the invocation request for playing music and lyrical music can be sent to a tool of the music playing type, so that the tool of the music playing type that is invoked performs the playing of lyrical quotes as a response to the request by the digital assistant.

In another example, an action execution parameter indicated in response to an inference result of the first-type machine learning model is “summarize the number of words of the article in 100 words or less”, and an action in the action sequence includes invoking a specified machine learning model to complete the text summarization. Then the electronic device can generate an input to the specified first-type machine learning model based on the action execution parameter, and an output of the specified first-type machine learning model can be used as a response to the request by the digital assistant based on the output of the specified first-type machine learning model.

In some embodiments, a response to the action sequence in the first inference rule comprises an invocation strategy for at least one tool, each tool being configured to perform at least one action of the action sequence. In this case, the electronic device generates an invocation request based on the action execution parameter; and sends the invocation request to an invocation address of a tool to cause the tool to perform at least one action of the action sequence, the invocation address being obtained by the invocation strategy.

Tools may be configured to execute corresponding actions based on action execution parameters, such that the results of executing the action may be used to determine a response to the request. Different tools may perform diverse actions, such as a tool that performs music playing, a tool that performs weather checking, a tool that performs takeout ordering, a tool that performs navigation, and so on.

The invocation of the tool depends on the invocation strategy of the tool. Taking the example that the tool being invoked is an audio playing type tool, the action execution parameters may correspond to the category of the song being played, such as lyrical music in the aforementioned example. In addition, the action execution parameters may also be other contents such as the name of the song, the name of the singer, the playing multiplication speed, and the like. The electronic device generates a corresponding invocation request based on the action execution parameters. After generating the invocation request, the invocation request can be sent to the invocation address of the invoked tool thereby enabling the invoked tool to execute at least one action of the action sequence. In conjunction with FIG. 4, it is shown that for the inference rule RULE1, after the two first-type machine learning models have obtained an inference result, the action sequence includes an invocation of the tool A1. If tool A1 is a music playing component, the invoked tool A1 can play lyrical music in combination with the request “play a lyrical song”.

The action sequence indicated to be executed in the inference rule is pre-configured. Therefore, in response to the action sequence including an invocation of a tool, the action sequence is configured with an invocation strategy for the tool. The invocation strategy includes at least an invocation address of the tool being invoked. Accordingly, the electronic device may send an invocation request to the invocation address in the invocation strategy, which may cause the invoked tool to perform at least one action of the action sequence.

In some embodiments, the action sequence in response to the first inference rule comprises an invocation strategy for at least one specified machine learning model, each specified machine learning model being configured to perform at least one action of the action sequence, in this case, the electronic device performs, based on the at least one action execution parameter, optimization processing on the request to obtain a prompt input; and sends the prompt input to an invocation address of a specified machine learning model to cause the specified machine learning model to perform at least one action of the action sequence, the invocation address being obtained by the invocation strategy.

The specified machine learning model may correspond to a first-type machine learning model or a second-type machine learning model. For example, the action sequence instructs the invocation of the at least one first-type machine learning model based on the inference results obtained by the first-type machine learning model, or the invocation of the at least one second-type machine learning model, and so on. Correspondingly, the invocation of the specified machine learning model may be oriented towards the output of the first-type machine learning model described in the previous section as a more ambiguous inference result or obtaining an accurate inference result. For example, if the output of the first-type machine learning model is relatively fuzzy, then a first-type machine learning model needs to be invoked again or a second-type machine learning model needs to be invoked again to perform secondary inference. For example, if the output of the first-type machine learning model is to obtain an accurate inference result, and the action sequence is invoked against another machine learning model based on the accurate inference result, then the machine learning model may also be invoked again to obtain a response to the request.

By way of example, after the electronic device obtains an inference result obtained for the first-type machine learning model, the action execution parameters in the inference result may be used to generate a prompt input for another specified machine learning model. For example, the request may be optimized based on the action execution parameters to generate the prompt input for the specified machine learning model. Furthermore, similar to tool invocations, information for indicating the invocation address is included in the invocation strategy for the specified machine learning model. As a result, the electronic device sends the model's prompt input to the specified machine learning model's invocation address to cause at least one of the specified machine learning model action sequences to be actuated. Still in conjunction with the example shown in FIG. 4, for the inference rule RULE3, the action sequence includes an invocation of the second-type machine learning model after the first-type machine learning model M₂ has obtained an inference result. That is, a prompt input can be generated from the inference result of the first-type machine learning model M₂, which is then sent to the second-type machine learning model, so that a response to the request can be accomplished with the second-type machine learning model. With the scenario corresponding to the example of inference rule RULE3, the first-type machine learning model M₂ can be used to perform some basic work first, and in this way a portion of the resources required for invoking or running the second-type machine learning model can be saved as compared to directly invoking the second-type machine learning model.

In some embodiments, in response to the action sequence in the first inference rule comprises an invocation strategy for a plurality of invoked objects, the invoked objects comprising at least one of a tool and a specified machine learning model, and each invoked object being configured to perform at least one action of the action sequence, in this case, the electronic device obtains an execution order of the plurality of invoked objects to be invoked; sends an invocation request that is generated based on the action execution parameter to an invocation address of an invoked object that is to be executed first in the execution order, the invocation address being obtained by the invocation strategy; and determines an execution result of the action sequence based on an action performed by each invoked object in the execution order.

Another scenario for action sequences is that a plurality of objects may be invoked at the same time. The order of execution of the plurality of invoked objects may be sequential, i.e., the input of the i-th invoked object is determined based on the output of the i-1st invoked object, i being a positive integer. Alternatively, the order of execution of the plurality of invoked objects may include parallel execution. If the execution is in parallel, then the correspondence can be abstracted as having a plurality of invoked objects being the first invoked object to be executed. The electronic device sends the invocation request generated based on the action execution parameters to an invocation address of the invoked object that is the first to be executed in the execution sequence. The invocation address may be determined in a manner that is obtained through an invocation strategy, which is obtained in the same manner as in the previous example and will not be repeated. Still in conjunction with the example shown in FIG. 4, for the inference rule RULE2, the action sequence includes invoking the tool A2 as well as invoking the first-type machine learning model M₄. Assuming that the execution order of the tool A2 and the first-type machine learning model M₄ are executed sequentially, a prompt input can be generated based on the result of the tool A2 and the prompt input can be sent to the first-type machine learning model M₄ to get a response to the request.

Each invoked object may complete at least one action of the action sequence based on the invocation request. The result of the execution action of the invoked object that executes last in the execution sequence may be taken as the result of the action sequence. Alternatively, it is also possible to take the result of the execution action of each invoked object as the result of the action sequence. Further, it is also possible to use the execution action results of some of the invoked objects as the result of the action sequence, as desired.

In some embodiments, at least one of the one or more inference rules is configured to perform inference on the request with a corresponding rule engine, the rule engine being configured to determine, from a mapping table, response content that matches the request. In this case, the electronic device obtains, based on the request, an inference result provided by the rule engine; and determines, based on the inference result, a response of the digital assistant to the request.

The inference rules may be associated with a rule engine in addition to a first-type machine learning model. The rule engine may be configured to determine from the mapping table whether the content of the response matches the request. Still in conjunction with FIG. 4, for inference rule RULE4, an example of this inference rule is one that utilizes a rule engine without utilizing the first-type machine computing models.

By way of example, static rules or other rules may be included in the rule engine. The static rules may be that if there is a specified content in the response request, then a response corresponding to the specified content may be generated. For example, by way of illustration, if the response request contains specified content such as “hello”, “good morning”, etc., a response corresponding to “hello”, a response corresponding to “good morning” may be generated.

Other rules can be more flexible replies to requests. For example, in addition to determining whether a request has specified content, other rules can also construct context mapping tables, sentiment mapping tables, etc., so as to obtain different replies by combining the mapping tables of specified content, context, and sentiment dimensions.

As shown in conjunction with FIG. 4, the electronic device may send the request to the inference rule RULE4 of the association rule engine. In response to the rule engine determining, via the mapping table, that there exists a response content matching the request, then the inference rule RULE4 may generate the response content. Since the mapping table is pre-written with replies corresponding to the specified content of the request, a faster response to the user can thus be accomplished without invoking the first-type machine learning model.

In some embodiments, the processing configuration includes more than one inference rule. The electronic device, in response to obtaining inference results of a plurality of inference rules all indicating successful inference, selects, based on priorities of the plurality of inference rules, a target inference result from the plurality of inference results; and determines, based on the target inference result, a response of the digital assistant to the request.

Still referring to FIG. 4, there are four inference rules included in FIG. 4. In constructing a processing configuration for the digital assistant, a priority may be set for each inference rule. In response to having a plurality of inference results of the inference rules indicating successful inference, then the electronic device may select the inference result obtained by the inference rule with the highest priority based on the priority of each inference rule. The inference result obtained by the inference rule with the highest priority may be one or a plurality of inference results. In the example shown in FIG. 4, the priorities of the inference rule RULE2 and the inference rule RULE3 are both a first priority. If the inference results of all four inference rules indicate successful inference, then the inference results of the inference rule RULE2 and the inference rule RULE3 can be determined as the target inference result.

In some embodiments, the electronic device may further determine a traffic field corresponding to the request; match the traffic field with a traffic field of each of the inference rules to determine at least one target inference rule; and perform, based on the at least one target inference rule, inference on the request by invoking the first-type machine learning model.

In constructing the processing configuration for the digital assistant, a traffic field may be set for each inference rule, and it is not difficult to understand that the first-type machine learning model associated with the inference rule may be the same traffic field as the inference rule. By way of example, the traffic field may be a music type, a navigation type, a store recommendation type, and so on. Correspondingly, after constructing the processing configuration for the digital assistant, the electronic device can obtain the business field corresponding to each inference rule.

The electronic device may accomplish identification of the traffic field corresponding to the request with a traffic field identification tool. The electronic device, based on the traffic field corresponding to the request, may match the traffic field with the traffic field of each inference rule, thereby identifying at least one target inference rule. In performing the distribution of the request to the inference rules, the target inference rule may be selected for distribution so as to perform inference on the request by the first-type machine learning model corresponding to the target inference rule. Still in conjunction with the example of FIG. 4, through the identification and matching of the traffic field, the request is identified as the traffic field 1. Then when the distribution is subsequently performed, the request can be distributed to only the inference rule RULE1 and the inference rule RULE2. As a result, resources can be saved even further, and efficiency can be increased.

In some embodiments, the electronic device determines a failure to process the request based on the processing configuration in response to obtaining an inference result obtained from the one or more inference rules indicating that a response to the request by the digital assistant fails to be determined.

If the inference results of the corresponding inference rules indicate that an inference result cannot be obtained, then it may be indicated that a plurality of inference rules in the processing configuration are unable to complete the identification of the request. Alternatively, if the execution of the action sequence to be executed in the inference rules fails (e.g., fails to successfully invoke the tool or invoke the specified machine learning model), this may also correspond to an inference result indicating that the digital assistant's response to the request cannot be determined. In this case, then, the second-type machine learning model can be invoked for processing.

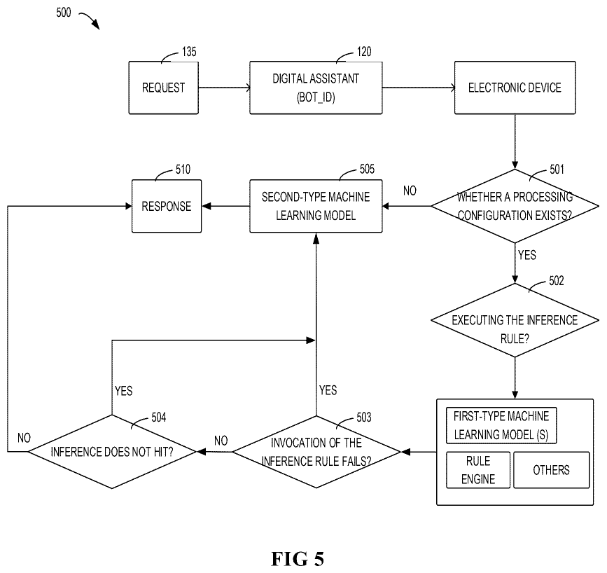

FIG. 5 shows a schematic diagram of an overall flow 500 of a method of task processing according to some embodiments of the present disclosure. At block 501, the electronic device first determines whether a processing configuration of the digital assistant 120 exists. The judgment of whether the processing configuration of the digital assistant 120 exists is also a judgment of whether there is an inference rule, and in response to the judgment result of yes, a subsequent inference process may be entered. Conversely, in response to the judgment result of no, then an inference utilizing the second-type machine learning model to perform inference on the request is performed at block 505 to determine the digital assistant's response to the request.

At block 502, the electronic device executes inference rules. Depending on the pre-configuration, each inference rule invokes an object associated with it. For example, a first-type machine learning model is invoked for inference, a rule engine is invoked for inference, etc.

At block 503, If the invocation of the inference rule for the associated object fails due to, for example, a network failure, the electronic device may execute the utilization of the second-type machine learning model to execute inference on the request to determine the digital assistant's response to the request at block 505. On the other hand, in response to the invocation being successful, a determination will also be made at block 504 as to whether the inference result indicates that the inference is successful, that is, whether the inference is a hit. In response to the inference not hitting, it will still be executed at block 505 to utilize the second-type machine learning model to execute the inference on the request. In response to the inference being successful, then the response 510 of the digital assistant 120 to the request can be determined based on the result of the inference.

The above describes the process of creating a digital assistant for some embodiments of the present disclosure. In embodiments of the present disclosure, the assistant creation platform provides sufficient support for the composition of digital assistants so as to enable a user to easily, quickly, flexibly, and freely create a desired digital assistant.

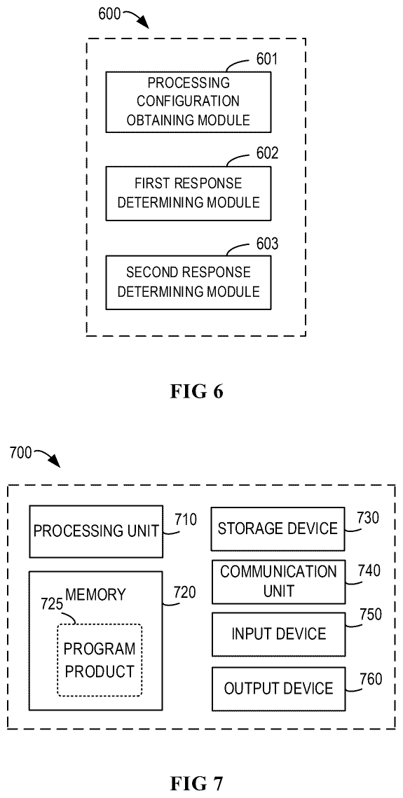

FIG. 6 shows a schematic structural block diagram of an example apparatus 600 for digital assistant creation according to some embodiments of the present disclosure. The apparatus 600 may be implemented, for example, in or comprised in the assistant creation platform 110. The various modules/components in the apparatus 600 may be implemented by hardware, software, firmware, or any combination thereof.

As shown, the apparatus 600 comprises a processing configuration obtaining module 601 configured to, in response to receiving a request for a digital assistant, obtain a processing configuration associated with the digital assistant, the processing configuration comprising one or more inference rules, at least one of the one or more inference rules being configured to perform inference on the request with a corresponding first-type machine learning model; a first response determining module 602 configured to process the request based on the processing configuration to determine a response of the digital assistant to the request, wherein processing the request based on the processing configuration at least comprises: performing, based on the at least one inference rule, inference on the request by invoking the first-type machine learning model; and a second response determining module 603 configured to, in response to a failure to process the request based on the processing configuration, perform inference on the request by invoking a second-type machine learning model to determine a response of the digital assistant to the request, wherein a resource cost of invoking the second-type machine learning model is greater than a resource cost of invoking the first-type machine learning model.

In some embodiments, each of the at least one inference rule indicates an invocation strategy for at least one first-type machine learning model, the invocation strategy comprising an invocation address and a model input requirement for the at least one first-type machine learning model. Based on this, for each of the at least one inference rule, the first response determining module 602 comprises a first-type machine learning model invoking module configured to generate, based on the model input requirement, a model input for each of the at least one first-type machine learning model; invoke, via the invocation address, the at least one first-type machine learning model with the generated model input respectively to obtain a model output; and determine an inference result for the request based on at least the model output corresponding to the at least one inference rule.

In some embodiments, each of the at least one inference rule further indicates an action sequence to be executed, and for a first inference rule of the at least one inference rule, the first response determining module 602 is configured to, in response to an inference result indicating at least one action execution parameter, execute an action sequence indicated by the first inference rule based on the at least one action execution parameter, the inference result being obtained by invoking a first-type machine learning model in the first inference rule; and determine a response of the digital assistant to the request based on an execution result of the action sequence

In some embodiments, the action sequence in the first inference rule comprises an invocation strategy for at least one tool, each tool being configured to perform at least one action of the action sequence. In this case, the first response determining module 602 is configured to generate an invocation request based on the action execution parameter; and send the invocation request to an invocation address of a tool to cause the tool to perform at least one action of the action sequence, the invocation address being obtained by the invocation strategy

In some embodiments, the action sequence in the first inference rule comprises an invocation strategy for at least one specified machine learning model, each specified machine learning model being configured to perform at least one action of the action sequence. In this case, the first response determining module 602 is configured to perform, based on the at least one action execution parameter, optimization processing on the request to obtain a prompt input; and send the prompt input to an invocation address of a specified machine learning model to cause the specified machine learning model to perform at least one action of the action sequence, the invocation address being obtained by the invocation strategy.

In some embodiments, the action sequence in the first inference rule comprises an invocation strategy for a plurality of invoked objects, the invoked objects comprising at least one of a tool and a specified machine learning model, and each invoked object being configured to perform at least one action of the action sequence. In this case, the first response determining module 602 is configured to obtain an execution order of the plurality of invoked objects to be invoked; send an invocation request that is generated based on the action execution parameter to an invocation address of an invoked object that is to be executed first in the execution order, the invocation address being obtained by the invocation strategy; and determine an execution result of the action sequence based on an action performed by each invoked object in the execution order.

In some embodiments, at least one of the one or more inference rules is configured to perform inference on the request with a corresponding rule engine, the rule engine being configured to determine, from a mapping table, response content that matches the request. In this case, the first response determining module 602 is configured to obtain, based on the request, an inference result provided by the rule engine; and determine, based on the inference result, a response of the digital assistant to the request.

In some embodiments, the processing configuration comprises more than one inference rule. In this case, the first response determining module 602 is configured to, in response to obtaining inference results of a plurality of inference rules all indicating successful inference, select, based on priorities of the plurality of inference rules, a target inference result from the plurality of inference results; and determine, based on the target inference result, a response of the digital assistant to the request.

In some embodiments, the first response determining module 602 comprises a request routing module configured to determine a traffic field corresponding to the request; match the traffic field with a traffic field of each of the inference rules to determine at least one target inference rule; and perform, based on the at least one target inference rule, inference on the request by invoking the first-type machine learning model.

In some embodiments, the second response determining module 603 comprises a processing result detecting module configured to determine a failure to process the request based on the processing configuration in response to obtaining an inference result obtained from the one or more inference rules indicating that a response to the request by the digital assistant fails to be determined.

FIG. 7 shows a block diagram of an example electronic device 700 in which one or more embodiments of the present disclosure may be implemented. It would be appreciated that the electronic device 700 shown in FIG. 7 is only an example and should not constitute any restriction on the function and scope of the embodiments described in this specification. The electronic device 700 shown in FIG. 7 may include or be implemented as the assistant creation platform 110 and/or the apparatus 600 of FIG. 6.

As shown in FIG. 7, the electronic device 700 is in the form of a general electronic device. The components of the electronic device 700 may include, but are not limited to, one or more processors or processing units 710, a memory 720, a storage device 730, one or more communication units 740, one or more input devices 750, and one or more output devices 760. The processing units 710 may be actual or virtual processors and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage media. Such media can be any available media that is accessible to the electronic device 700, including but not limited to volatile and non-volatile media, removable and non-removable media. The memory 720 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 730 can be any removable or non-removable medium, and can include machine-readable medium, such as a flash drive, a disk, or any other medium which can be used to store information and/or data and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 can include a computer program product 725, which comprises one or more program modules configured to execute various methods or actions of the various embodiments disclosed in this specification.

The communication unit 740 implements communication with other electronic devices via a communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to some example implementations of the present disclosure, a computer-readable storage medium is provided, on which a computer-executable instruction or computer program is stored, wherein the computer-executable instructions are executed by a processor to implement the methods described above. In accordance with example implementations of the present disclosure, there is also provided a computer program product which is tangibly stored on a non-transitory computer-readable medium and comprises computer-executable instructions, and the computer-executable instructions are executed by a processor to implement the methods described above.

Various aspects of the present disclosure are described in this specification with reference to the flow chart and/or the block diagram of the method, the device, the apparatus and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description provides a number of examples, not exhaustive, and is not limited to the disclosed implementations. Without departing from the scope and spirit of the described implementations, many modifications and changes are obvious to one of ordinary skill in the art. The selection of terms used in this article aims to best explain the principles, practical application or improvement of technology in the market of each implementation, or to enable others of ordinary skill in the art to understand the various embodiments disclosed in this specification.

1. A method of task processing, comprising:
in response to receiving a request for a digital assistant, obtaining a processing configuration associated with the digital assistant, the processing configuration comprising one or more inference rules, at least one of the one or more inference rules being configured to perform inference on the request using a corresponding first-type machine learning model; processing the request based on the processing configuration to determine a response of the digital assistant to the request, wherein processing the request based on the processing configuration comprises: performing, based on the at least one inference rule, inference on the request by invoking the corresponding first-type machine learning model; and
in response to a failure to process the request based on the processing configuration, performing inference on the request by invoking a second-type machine learning model to determine a response of the digital assistant to the request, wherein a resource cost of invoking the second-type machine learning model is greater than a resource cost of invoking the first-type machine learning model.

2. The method of claim 1, wherein each of the at least one inference rule indicates an invocation strategy for at least one first-type machine learning model, the invocation strategy comprising an invocation address and a model input requirement for each of the at least one first-type machine learning model, and
wherein performing inference on the request by invoking the first-type machine learning model comprises:
for each of the at least one inference rule,
generating, based on the model input requirement, a model input for each of the at least one first-type machine learning model,
invoking, via the corresponding invocation address, the at least one first-type machine learning model with the generated model input respectively to obtain a model output; and
determining an inference result for the request based on at least the model output corresponding to the at least one inference rule.

3. The method of claim 1, wherein each of the at least one inference rule further indicates an action sequence to be executed, and wherein processing the request based on the processing configuration further comprises: for a first inference rule of the at least one inference rule,
in response to an inference result indicating at least one action execution parameter, executing an action sequence indicated by the first inference rule based on the at least one action execution parameter, the inference result being obtained by invoking a first-type machine learning model in the first inference rule; and
determining a response of the digital assistant to the request based on an execution result of the action sequence.

4. The method of claim 3, wherein the action sequence in the first inference rule comprises an invocation strategy for at least one tool, each tool being configured to perform at least one action of the action sequence, and
wherein executing an action sequence indicated by the first inference rule based on the at least one action execution parameter comprises:
generating an invocation request based on the at least one action execution parameter; and
sending the invocation request to an invocation address of a tool to cause the tool to perform at least one action of the action sequence, the invocation address being obtained by the invocation strategy.

5. The method of claim 3, wherein the action sequence in the first inference rule comprises an invocation strategy for at least one specified machine learning model, each specified machine learning model being configured to perform at least one action of the action sequence, and
wherein executing an action sequence indicated by the first inference rule based on the at least one action execution parameter comprises:
performing, based on the at least one action execution parameter, optimization processing on the request to obtain a prompt input; and
sending the prompt input to an invocation address of a specified machine learning model to cause the specified machine learning model to perform at least one action of the action sequence, the invocation address being obtained by the invocation strategy.

6. The method of claim 3, wherein the action sequence in the first inference rule comprises an invocation strategy for a plurality of invoked objects, the invoked objects comprising at least one of a tool and a specified machine learning model, and each invoked object being configured to perform at least one action of the action sequence, and
wherein executing the action sequence indicated by the first inference rule based on the at least one action execution parameter comprises:
obtaining an execution order of the plurality of invoked objects to be invoked; sending an invocation request that is generated based on the action execution parameter to an invocation address of an invoked object that is to be executed first in the execution order, the invocation address being obtained by the invocation strategy; and
determining an execution result of the action sequence based on an action performed by each invoked object in the execution order.

7. The method of claim 1, wherein at least one of the one or more inference rules is configured to perform inference on the request with a corresponding rule engine, the rule engine being configured to determine, from a mapping table, response content matches the request, and
wherein the processing the request based on the processing configuration to determine a response of the digital assistant to the request further comprises:
obtaining, based on the request, an inference result provided by the rule engine; and
determining, based on the inference result, a response of the digital assistant to the request.

8. The method of claim 1, wherein the processing configuration comprises more than one inference rule, and wherein processing the request based on the processing configuration to determine a response of the digital assistant to the request comprises:
in response to obtaining a plurality of inference results of a plurality of inference rules all indicating successful inference, selecting, based on priorities of the plurality of inference rules, a target inference result from the plurality of inference results; and
determining, based on the target inference result, a response of the digital assistant to the request.

9. The method of claim 1, wherein processing the request based on the processing configuration further comprises:
determining a traffic field corresponding to the request;
matching the traffic field with a traffic field of each of the inference rules to determine at least one target inference rule; and
performing, based on the at least one target inference rule, inference on the request by invoking the first-type machine learning model.

10. The method of claim 1, wherein a failure to process the request based on the processing configuration is determined by:
determining a failure to process the request based on the processing configuration in response to obtaining an inference result obtained from the one or more inference rules indicating that a response to the request by the digital assistant fails to be determined.

11. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
in response to receiving a request for a digital assistant, obtaining a processing configuration associated with the digital assistant, the processing configuration comprising one or more inference rules, at least one of the one or more inference rules being configured to perform inference on the request using a corresponding first-type machine learning model;
processing the request based on the processing configuration to determine a response of the digital assistant to the request, wherein processing the request based on the processing configuration at least comprises:
performing, based on the at least one inference rule, inference on the request by invoking the corresponding first-type machine learning model; and
in response to a failure to process the request based on the processing configuration, performing inference on the request by invoking a second-type machine learning model to determine a response of the digital assistant to the request, wherein a resource cost of invoking the second-type machine learning model is greater than a resource cost of invoking the first-type machine learning model.

12. The electronic device of claim 11, wherein each of the at least one inference rule indicates an invocation strategy for at least one first-type machine learning model, the invocation strategy comprising an invocation address and a model input requirement for each of the at least one first-type machine learning model, and
wherein performing inference on the request by invoking the first-type machine learning model comprises:
for each of the at least one inference rule,
generating, based on the model input requirement, a model input for each of the at least one first-type machine learning model,
invoking, via the corresponding invocation address, the at least one first-type machine learning model with the generated model input respectively to obtain a model output; and
determining an inference result for the request based on at least the model output corresponding to the at least one inference rule.

13. The electronic device of claim 11, wherein each of the at least one inference rule further indicates an action sequence to be executed, and wherein processing the request based on the processing configuration further comprises:
for a first inference rule of the at least one inference rule,
in response to an inference result indicating at least one action execution parameter, executing an action sequence indicated by the first inference rule based on the at least one action execution parameter, the inference result being obtained by invoking a first-type machine learning model in the first inference rule; and
determining a response of the digital assistant to the request based on an execution result of the action sequence.

14. The electronic device of claim 13, wherein the action sequence in the first inference rule comprises an invocation strategy for at least one tool, each tool being configured to perform at least one action of the action sequence, and
wherein executing an action sequence indicated by the first inference rule based on the at least one action execution parameter comprises:
generating an invocation request based on the at least one action execution parameter; and
sending the invocation request to an invocation address of a tool to cause the tool to perform at least one action of the action sequence, the invocation address being obtained by the invocation strategy.

15. The electronic device of claim 13, wherein the action sequence in the first inference rule comprises an invocation strategy for at least one specified machine learning model, each specified machine learning model being configured to perform at least one action of the action sequence, and
wherein executing an action sequence indicated by the first inference rule based on the at least one action execution parameter comprises:
performing, based on the at least one action execution parameter, optimization processing on the request to obtain a prompt input; and
sending the prompt input to an invocation address of a specified machine learning model to cause the specified machine learning model to perform at least one action of the action sequence, the invocation address being obtained by the invocation strategy.

16. The electronic device of claim 13, wherein the action sequence in the first inference rule comprises an invocation strategy for a plurality of invoked objects, the invoked objects comprising at least one of a tool and a specified machine learning model, and each invoked object being configured to perform at least one action of the action sequence, and
wherein executing the action sequence indicated by the first inference rule based on the at least one action execution parameter comprises:
obtaining an execution order of the plurality of invoked objects to be invoked;
sending an invocation request that is generated based on the action execution parameter to an invocation address of an invoked object that is to be executed first in the execution order, the invocation address being obtained by the invocation strategy; and
determining an execution result of the action sequence based on an action performed by each invoked object in the execution order.

17. The electronic device of claim 11, wherein at least one of the one or more inference rules is configured to perform inference on the request with a corresponding rule engine, the rule engine being configured to determine, from a mapping table, response content matches the request, and
wherein the processing the request based on the processing configuration to determine a response of the digital assistant to the request further comprises:
obtaining, based on the request, an inference result provided by the rule engine; and
determining, based on the inference result, a response of the digital assistant to the request.

18. The electronic device of claim 11, wherein the processing configuration comprises more than one inference rule, and wherein processing the request based on the processing configuration to determine a response of the digital assistant to the request comprises:
in response to obtaining a plurality of inference results of a plurality of inference rules all indicating successful inference, selecting, based on priorities of the plurality of inference rules, a target inference result from the plurality of inference results; and
determining, based on the target inference result, a response of the digital assistant to the request.

19. The electronic device of claim 11, wherein processing the request based on the processing configuration further comprises:
determining a traffic field corresponding to the request;
matching the traffic field with a traffic field of each of the inference rules to determine at least one target inference rule; and
performing, based on the at least one target inference rule, inference on the request by invoking the first-type machine learning model.

20. A non-transitory computer-readable storage medium having a computer program stored thereon, the computer program being executable by a processor to implement acts comprising:
in response to receiving a request for a digital assistant, obtaining a processing configuration associated with the digital assistant, the processing configuration comprising one or more inference rules, at least one of the one or more inference rules being configured to perform inference on the request using a corresponding first-type machine learning model;
processing the request based on the processing configuration to determine a response of the digital assistant to the request, wherein processing the request based on the processing configuration at least comprises: performing, based on the at least one inference rule, inference on the request by invoking the corresponding first-type machine learning model; and
in response to a failure to process the request based on the processing configuration, performing inference on the request by invoking a second-type machine learning model to determine a response of the digital assistant to the request, wherein a resource cost of invoking the second-type machine learning model is greater than a resource cost of invoking the first-type machine learning model.
